(19) United States
(12) Patent Application Publication
(10) Pub. No.: US 2005/0169379 A1
(43) Pub. Date: Aug. 4, 2005

(54) Apparatus and method for scalable video coding providing scalability in encoder part

(75) Inventors: Sung-chol Shin, Suwon-si (KR); Woo-jin Han, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/043,929

(22) Filed: Jan. 28, 2005

(30) Foreign Application Priority Data
Jan. 29, 2004 (KR) 10-2004-0005822

(51) Int. Cl. H04N 7/12

(52) U.S. Cl. 375/240.16; 375/240.12; 375/240.18

(57) ABSTRACT

A method and apparatus for scalable encoding providing scalability in an encoder. The scalable video encoding apparatus includes a mode selector that determines a temporal filtering order of a frame and a predetermined time limit as a condition for determining to which frame temporal filtering is to be performed, and a temporal filter which performs motion compensation and temporal filtering, according to the temporal filtering order determined in the mode selector, on frames that satisfy the above-described condition. According to the method and apparatus, since scalability is provided in the encoder, stability in the operation of real-time, bidirectional video streaming applications, such as video conferencing, can be ensured.

### CROSS-REFERENCE TO RELATED APPLICATION

This application claims priority from Korean Patent Application No. 10-2004-0005822 filed on Jan. 29, 2004 in the Korean Intellectual Property Office, the disclosure of which is incorporated herein by reference in its entirety.

### BACKGROUND OF THE INVENTION

1. Field of the Invention

The present invention relates to video compression and, more particularly, to an apparatus and method for scalable video coding providing scalability during temporal filtering in the course of scalable video coding.

2. Description of the Related Art

With the development of information communication technology, including the Internet, video communication as well as text and voice communication, has increased dramatically. Conventional text communication cannot satisfy users' various demands, and thus, multimedia services that can provide various types of information such as text, pictures, and music have increased. However, multimedia data requires a storage media that have a large capacity and a wide bandwidth for transmission since the amount of multimedia data is usually large. Accordingly, a compression coding method is requisite for transmitting multimedia data including text, video, and audio.

A basic principle of data compression is removing data redundancy. Data can be compressed by removing spatial redundancy in which the same color or object is repeated in an image, temporal redundancy in which there is little change between adjacent frames in a moving image or the same sound is repeated in audio, or mental visual redundancy which takes into account human eyesight and its limited perception of high frequency. Data compression can be classified into lossy compression or lossless compression according to whether source data is lost or not, respectively; intraframe compression or interframe compression according to whether individual frames are compressed independently or with reference to other frames, respectively; and symmetric compression or asymmetric compression according to whether the time required for compression is the same as the time required for recovery or not, respectively. Data compression is defined as real-time compression when a compression/recovery time delay does not exceed 50 ms and is defined as scalable compression when frames have different resolutions. For text or medical data, lossless compression is usually used. For multimedia data, lossy compression is usually used. Meanwhile, intraframe compression is usually used to remove spatial redundancy, and interframe compression is usually used to remove temporal redundancy.

Different types of transmission media for multimedia have different performance. Currently used transmission media have various transmission rates. For example, an ultrahigh-speed communication network can transmit data of several tens of megabits per second while a mobile communication network has a transmission rate of 384 kilobits per second. In conventional video coding methods, such as Motion Picture Experts Group (MPEG)-1, MPEG-2, H.263, and H.264, temporal redundancy is removed by motion compensation based on motion estimation, and spatial redundancy is removed by transform coding. These methods have satisfactory compression rates, but they do not have the flexibility of a truly scalable bitstream since they use a reflexive approach in a main algorithm. Accordingly, to support transmission media having various speeds or to transmit multimedia at a data rate suitable to a transmission environment, data coding methods having scalability, such as wavelet video coding and subband video coding, may be suitable to a multimedia environment. Scalability indicates the ability to partially decode a single compressed bitstream.

Scalability includes spatial scalability indicating a video resolution, Signal to Noise Ratio (SNR) scalability indicating a video quality level, temporal scalability indicating a frame rate, and a combination thereof.

FIG. 1 is a block diagram of a structure of a conventional scalable video encoder.

First, an input video sequence is divided into groups of pictures (GOPs), which are basic encoding units, and encoding is performed on each GOP.

A motion estimation unit 1 performs motion estimation on a current frame using a frame among the GOPs stored in a buffer (not shown) as a reference frame, thereby obtaining a motion vector.

A temporal filter 2 removes temporal redundancy between frames using the obtained motion vector, thereby generating a temporal residual image, i.e. a temporal filtered frame.

A spatial transform unit 3 performs a wavelet transform on the temporal residual image, thereby generating a transform coefficient, i.e., a wavelet coefficient.

A quantizer 4 quantizes the generated wavelet coefficient.

A bitstream generating unit 5 generates a bitstream by encoding the quantized transform coefficient and the motion vector generated by the motion estimation unit 1.

One technique, among many, used for wavelet-based scalable video coding is motion compensated temporal filtering (MCTF), which was introduced by Jens-Rainer Ohm and improved by Seung-Jong Choi and John W. Woods. MCTF is an essential technique for removing temporal redundancy and for video coding having flexible temporal scalability. According to the MCTF scheme, coding is performed in units of GOPs and a pair of frames (a current frame and a reference frame) is temporally filtered in a moving direction, which will now be described with reference to FIG. 2.

FIG. 2 schematically illustrates a temporal decomposition process in scalable video coding and decoding based on Motion Compensated Temporal Filtering (MCTF).

In FIG. 2, an L frame is a low frequency frame corresponding to an average of the frames while an H frame is a high frequency frame corresponding to a difference between the frames. As shown in FIG. 2, in a coding process, pairs of frames at a low temporal level are temporally filtered and then decomposed into pairs of L frames and H frames at a higher temporal level. The pairs of L frames and H frames are again temporally filtered and decomposed into frames at a higher temporal level.

An encoder performs wavelet transformation on the H frames and one L frame at the highest temporal level and generates a bitstream. Frames indicated by shading in FIG. 2 are subjected to a wavelet transform. That is, frames are coded from a low temporal level to a high temporal level.

A decoder performs the inverse operation of the encoder on the shaded frames (FIG. 2). The shaded frames are obtained by inverse wavelet transformation from a high level to a low level for reconstructions. That is, L and H frames at temporal level 3 are used to reconstruct two L frames at temporal level 2, and the two L frames and the two H frames at temporal level 2 are used to reconstruct four L frames at temporal level 1. Finally, the four L frames and the four H frames at temporal level 1 are used to reconstruct eight frames.

Such MCTF-based video coding has an advantage of improved flexible temporal scalability but has disadvantages such as unidirectional motion estimation and poor performance in a low temporal rate. Many approaches have been researched and developed to overcome these disadvantages. One of them is unconstrained MCTF (UMCTF) proposed by Deepak S. Turaga and Mihaela van de Schaar, which will be described with reference to FIG. 3.

FIG. 3 schematically illustrates temporal decomposition during scalable video coding and decoding using UMCTF.

UMCTF allows a plurality of reference frames and bi-directional filtering to be used and, thereby, provides a more generic framework. In addition, in a UMCTF scheme, non-dyadic temporal filtering is feasible by appropriately inserting an unfiltered frame, i.e., an A-frame. UMCTF uses A-frames instead of filtered L-frames, thereby considerably increasing the quality of pictures at a low temporal level because accurate motion estimation of L frames may lower the quality of pictures. A variety of experimental results have proven that UMCTF in which an updating process of frames is skipped sometimes exhibited better performance than MCTF.

In numerous video applications, such as video conferencing, video data is encoded at an encoder in a real-time basis and the encoded video data is restored at a decoder that has received the encoded data through a predetermined communication medium.

However, when it is difficult to encode data at a given frame rate, a delay may occur at the encoder so that the video data cannot be transmitted smoothly in real time. This delay may occur for several reasons, including insufficient processing power of the encoder, insufficient system resources even though the encoder has sufficient processing power, increased resolution of input video data, an increase in the number of bits per frame, and so on.

Thus, a variety of situations that may affect the encoder must be taken into consideration. For example, assuming that the input video data is composed of N frames per GOP, when the processing power of the encoder is not enough to encode the N frames in real time, transmission of the frames should be made frame by frame whenever the encoding of each frame has been performed and the encoding should be stopped if a predetermined time limit has elapsed.

Although encoding has stopped before all the frames have been completely processed, the decoder only decodes the processed frames to a possible temporal level, thereby reducing the frame rate. However, there still exists a need for restoring video data in real time.

In both the MCTF and UMCTF schemes, however, frames ranging from the lowest temporal level are analyzed at an encoder and then transmitted sequentially to a decoder in the encoded order, while, at the decoder, frames ranging from the highest temporal level are restored first. Thus, decoding cannot be performed until all the frames in GOPs are received from the encoder. In other words, a temporal level at which only some of the frames received from the encoder are decoded is not available, suggesting that scalability in an encoder is not supported.

However, temporal scalability of an encoder is very advantageously used in bidirectional video streaming applications. Therefore, when processing power is not sufficient for encoding, processing should be stopped at the current temporal level for immediate transmission of the bitstream. In this regard, however, the existing methods do not achieve such a flexible temporal scalability in the encoder.

### SUMMARY OF THE INVENTION

The present invention provides an apparatus and method for scalable video coding providing scalability in an encoder.

The present invention also provides an apparatus and method for providing information on some frames encoded in an encoder within a limited time to a decoder by using a header of a bitstream.

According to an aspect of the present invention, a scalable video encoding apparatus comprises a mode selector that determines a temporal filtering order of a frame and a predetermined time limit as a condition for determining to which frame temporal filtering is to be performed, and a temporal filter which performs motion compensation and temporal filtering, according to the temporal filtering order determined in the mode selector, on frames that satisfy the above-described condition.

The predetermined time of limit may be determined to enable smooth, real-time streaming.

The temporal filtering order may be in an order from frames of a high temporal level to frames of a low temporal level.

The scalable video encoding apparatus may further comprise a motion estimator that obtains motion vectors between a frame currently being subjected to temporal filtering and a reference frame corresponding to the current frame. The motion estimator then transfers the reference frame number and the obtained motion vectors to the temporal filter for motion compensation.

In addition, the scalable video encoding apparatus may further comprise a spatial transform unit that removes spatial redundancies from the temporally filtered frames to generate transform coefficients and a quantizer that quantizes the transform coefficients.

The scalable video encoding apparatus may further comprise a bitstream generator that generates a bitstream containing the quantized transform coefficients, the motion vectors obtained from the motion estimator, the temporal filtering order transferred from the mode selector, and the frame number of the last frame in the temporal filtering order among frames satisfying the predetermined time limit.

The temporal filtering order may be recorded in a GOP header contained in each GOP within the bitstream.

The frame number of the last frame may be recorded in a frame header contained in each frame within the bitstream.

The scalable video encoding apparatus may further comprise a bitstream generator which generates a bitstream containing the quantized transform coefficients, the motion vectors obtained from the motion estimator, the temporal filtering order transferred from the mode selector, and the information on a temporal level formed by the frames satisfying the predetermined time limit.

The information on the temporal level is recorded in a GOP header contained in each GOP within the bitstream.

According to another aspect of the present invention, a scalable video decoding apparatus comprises a bitstream interpreter that interprets an input bitstream to extract information on encoded frames, motion vectors, a temporal filtering order of the frames, and a temporal level of frames to be subjected to inverse temporal filtering; and an inverse temporal filter that performs inverse temporal filtering on a frame corresponding to the temporal level among the encoded frames to restore a video sequence.

According to still another aspect of the present invention, a scalable video decoding apparatus comprises a bitstream interpreter that interprets an input bitstream to extract information on encoded frames, motion vectors, a temporal filtering order of the frames, and a temporal level of frames to be subjected to inverse temporal filtering; an inverse quantizer that performs inverse quantization on the information on encoded frames to generate transform coefficients; an inverse spatial transform unit that performs inverse spatial transformation on the generated transform coefficients to generate temporally filtered frames; and an inverse temporal filter that performs inverse temporal filtering on a frame corresponding to the temporal level among the temporally filtered frames to restore a video sequence.

The information on the temporal level may be the frame number of the last frame in the temporal filtering order among the encoded frames.

The information on the temporal level may be the temporal level determined when encoding the bitstream.

According to yet another aspect of the present invention, a scalable video encoding method comprises determining an order of temporally filtering a frame and a predetermined time limit as a condition for determining to which frame temporal filtering is to be performed on the frame, and performing motion compensation and temporal filtering, according to the determined temporal filtering order, on frames that satisfy the above-described condition.

The scalable video encoding method may further comprise obtaining motion vectors between a frame currently being subjected to temporal filtering and a reference frame corresponding to the current frame.

According to another aspect of the present invention, a scalable video decoding method comprises interpreting an input bitstream to extract information on encoded frames, motion vectors, a temporal filtering order of the frames, and a temporal level of frames to be subjected to inverse temporal filtering; and performing inverse temporal filtering on a frame corresponding to the temporal level among the encoded frames to restore a video sequence.

### BRIEF DESCRIPTION OF THE DRAWINGS

The above and other features and advantages of the present invention will become more apparent by describing in detail preferred embodiments thereof with reference to the accompanying drawings, in which:

FIG. 1 is a block diagram of a conventional scalable video encoder;

FIG. 2 schematically illustrates a temporal decomposition process in a scalable video coding and decoding based on Motion Compensated Temporal Filtering (MCTF);

FIG. 3 schematically illustrates a temporal decomposition process in scalable video coding and decoding based on Unconstrained Motion Compensated Temporal Filtering (UMCTF);

FIG. 4 is a diagram showing all possible connections among frames in a Successive Temporal Approximation and Referencing (STAR) algorithm;

FIG. 5 illustrates a basic conception of the STAR algorithm according to an embodiment of the present invention;

FIG. 6 illustrates bidirectional prediction and cross-GOP optimization used in the STAR algorithm according to an embodiment of the present invention;

FIG. 7 illustrates non-dyadic temporal filtering in the STAR algorithm according to an embodiment of the present invention;

FIG. 8 is a block diagram of a scalable video encoder according to an embodiment of the present invention;

FIG. 9 is a block diagram of a scalable video encoder according to an embodiment of the present invention;

FIG. 10 is a block diagram of a scalable video decoder according to an embodiment of the present invention;

FIG. 11A schematically illustrates the overall structure of a bitstream generated by an encoder;

FIG. 11B is a detailed diagram of a GOP field;

FIG. 11C is a detailed diagram of an MC field;

FIG. 11D is a detailed diagram of a ‘the other T’ field; and

FIG. 12 is a diagram illustrating a system for performing an encoding, pre-decoding, or decoding method according to an embodiment of the present invention.

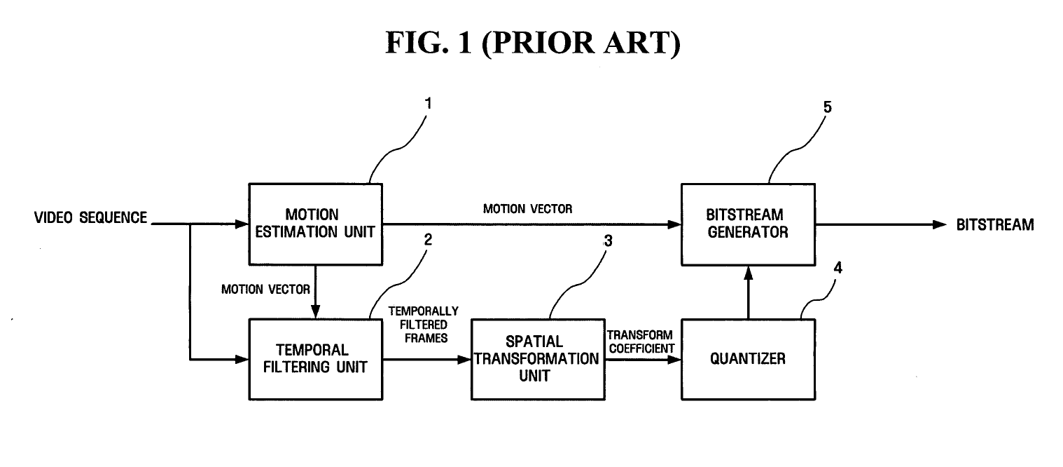

### DETAILED DESCRIPTION OF ILLUSTRATIVE, NON-LIMITING EMBODIMENTS OF THE INVENTION

The present invention will now be described more fully with reference to the accompanying drawings, in which exemplary embodiments of the invention are shown. Advantages and features of the present invention and methods of accomplishing the same may be understood more readily by reference to the following detailed description of exemplary embodiments and the accompanying drawings. The present invention may, however, be embodied in many different forms and should not be construed as being limited to the embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

In order to implement temporal scalability in an encoder according to the present invention, it is preferable to employ a scheme different from the conventional MCTF or UMCTF, in which encoding is performed from a low temporal level to a high temporal level and decoding is then performed from a high temporal level to a low temporal level. That is, it is preferable that the present invention be implemented using a scheme in which encoding and decoding directions are identical.

Therefore, the present invention proposes a method of performing encoding from a high temporal level to a low temporal level and then performing decoding in the same order, thereby achieving temporal scalability. A temporal filtering method according to the present invention, which is distinguished from the conventional MCTF or UMCTF, will be defined as a Successive Temporal Approximation and Referencing (STAR) algorithm.

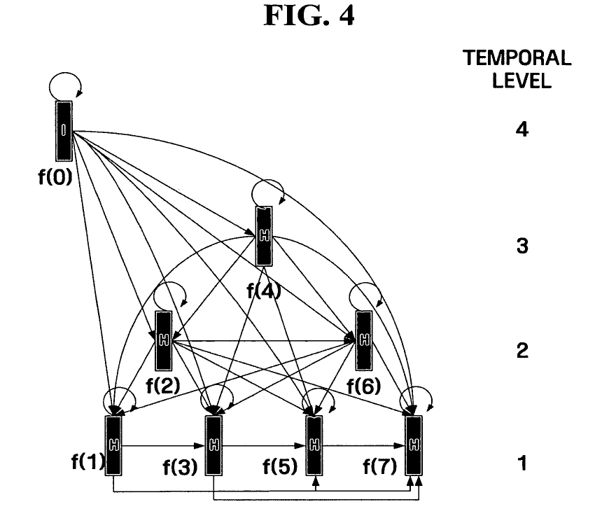

FIG. 4 is a diagram showing all possible connections among frames in a Successive Temporal Approximation and Referencing (STAR) algorithm when a GOP size is 8. In FIG. 4, an arrow starting from a frame and returning back to the same frame indicates prediction in an intra mode.

All of the original frames having coded frame index, including frames at H-frame positions at the same temporal level, can be used as reference frames.

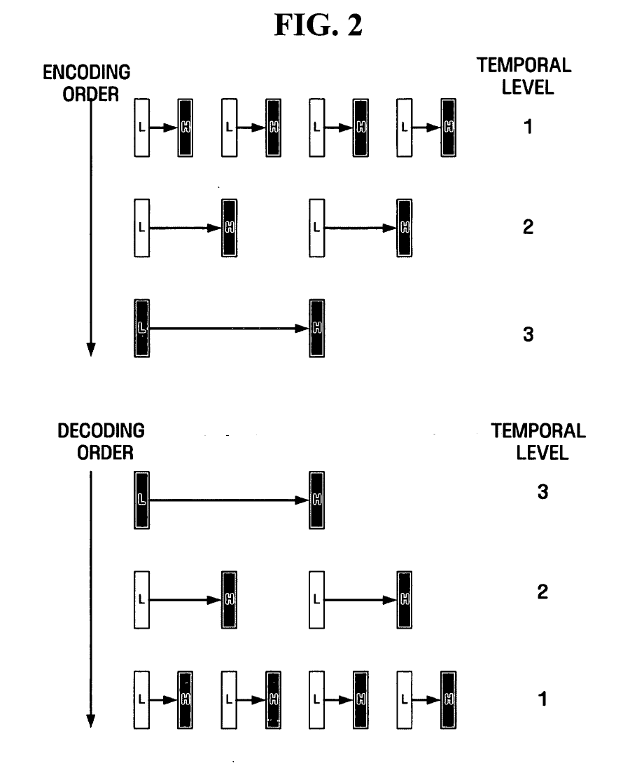

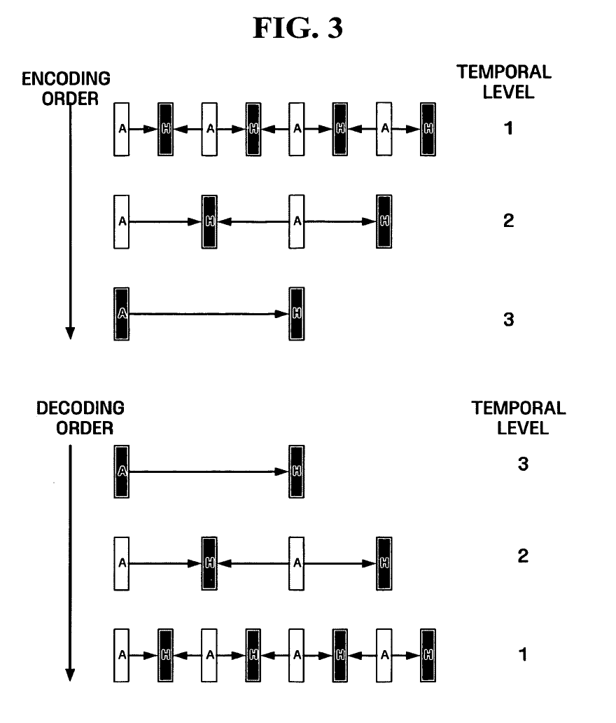

However, in the conventional technology, original frames at H-frame positions can only refer to an A-frame or an L-frame among frames at the same temporal level, as shown in FIGS. 2 and 3. This is one of differences between the conventional methods and methods according to the present invention.

Although use of multiple reference frames results in an increase in the amount of memory for temporal filtering and also results in a processing delay, its use in the encoding process is valuable.

Although a frame having the highest temporal level in a GOP has been illustrated as one having the smallest frame index in exemplary embodiments of present invention, the present invention can also be used for a frame having a frame index that is not the smallest frame index.

For a better understanding of the present invention, the invention will be described on the assumption that the number of reference frames for coding a frame, for bidirectional prediction, is restricted to 2. For a unidirectional prediction, the number of reference frames for coding a frame will be restricted to 1.

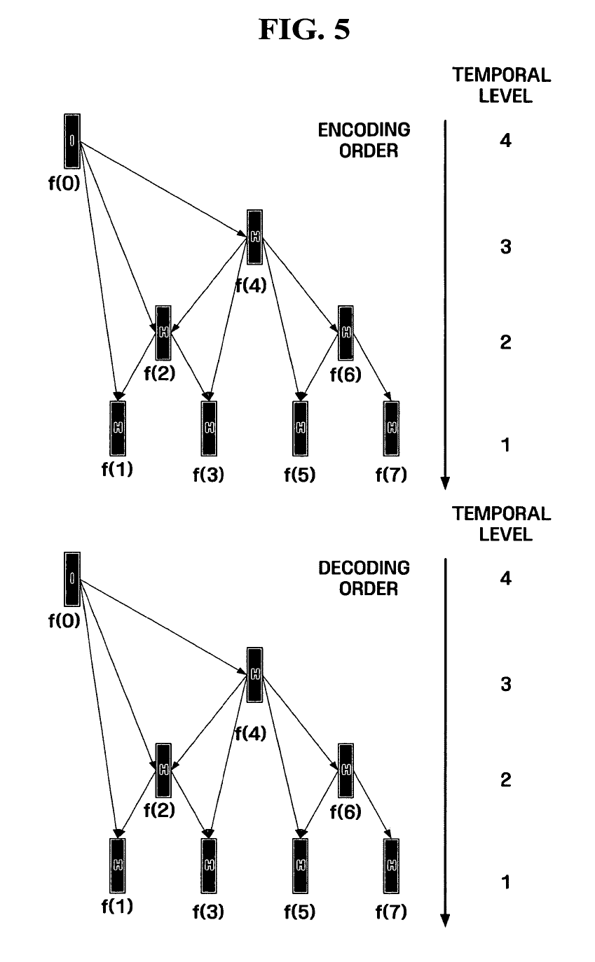

FIG. 5 illustrates a basic conception of the STAR algorithm according to an embodiment of the present invention.

In the basic conception of the STAR algorithm, all frames at each temporal level are expressed as nodes and a referencing relationship is expressed by an arrow. Only the required number of frames can be positioned at each temporal level. For example, only a single frame among frames in a GOP can be positioned at a highest temporal level. In the illustrative embodiment of the present invention, a frame f(0) has the highest temporal level. At subsequent lower temporal levels, temporal analysis is successively performed and error frames having a high-frequency component are predicted from original frames having coded frame indexes. When a GOP size is 8, the frame f(0) is coded into an I-frame at the highest temporal level. At a subsequent lower temporal level, a frame f(4) is encoded into an interframe, i.e., an H-frame, using the frame f(0). Subsequently, frames f(2) and f(6) are coded into interframes using the frames f(0) and f(4). Lastly, frames f(1), f(3), f(S), and f(7) are coded into interframes using the frames f(0), f(2), f(4), and f(6).

In the decoding procedures based on the STAR algorithm, the frame f(0) is decoded first. Then, the frame f(4) is decoded referring to the frame f(0). Similarly, the frames f(2) and f(6) are decoded referring to the frames f(0) and f(4). Lastly, the frames f(1), f(3), f(5), and f(7) are decoded referring to the frames f(0), f(2), f(4) and f(6).

As shown in FIG. 5, both the encoder and the decoder experience the same temporal procedure. Due to this characteristic, temporal scalability can be provided to the encoder. In other words, although the encoder stops encoding at a predetermined temporal level, the decoder can perform decoding to the corresponding temporal level. That is, since frames are coded from a high temporal level, temporal scalability can be provided at the encoder. For example, if coding is stopped after the frame f(6) is coded, the decoder restores the frame f(4) referring to the frame f(0). Also, the decoder restores the frames f(2) and f(6) referring to the frames f(0) and f(4). In this case, the decoder outputs the frames f(0), f(2), f(4), and f(6) as video streams. In order to maintain temporal scalability in the encoding part, a frame having the highest temporal level, e.g., the frame f(0) in the illustrative embodiment of the present invention, must be coded as an I frame, which requires operations with other frames, rather than as an L frame.

As illustrated in FIG. 5, temporal scalability may be supported in both the decoder and the encoder according to the present invention. However, the conventional MCTF or UMCTF based scalable video coding cannot support the temporal scalability in the encoder. In other words, referring to FIGS. 2 and 3, in order for the decoder to perform decoding, L or A frames of temporal level 3 are required. Based on the MCTF or UMCTF algorithms, the L or A frames, which have the highest temporal level, cannot be obtained until encoding is completed. On the other hand, decoding can be stopped at any temporal level.

Requirements for maintaining temporal scalability in both the encoding and decoding parts will now be described.

Suppose F(k) indicates a frame having a frame index of k, and T(k) indicates a temporal level of the frame having a frame index of k. In order to provide temporal scalability, a frame having a lower temporal level than a frame having a predetermined temporal level cannot be referenced in coding the frame having a predetermined temporal level. For example, the frame f(4) cannot refer to the frame f(2). If the frame f(4) is allowed to refer to the frame f(2), encoding cannot be stopped in the frames f(O) and f(4), which means that the frame f(4) cannot be coded until the frame f(2) is coded. A set Rk consisting of reference frames that can be referred to by the frame F(k), is defined by Equation 1:
Rk={F(1)(T(1)>T(k)) or ((T(1)=T(k)) and (1<=k))} [Equation 1]
where 1 indicates a frame index.

Meanwhile, the relationships (T(1)=T(k)) and (1<=k) mean that the frame F(k) is subjected to temporal filtering referring to itself, which is called an intra mode.

Encoding and decoding processes using the STAR algorithm may be performed as follows:

In the encoding process, first, a first frame in a GOP is encoded as an I-frame.

Second, motion estimation is performed on frames at the next temporal level, followed by encoding using reference frames defined by Equation (1). In the same temporal level, encoding is performed starting from the leftmost frame toward the rightmost (in order from the lowest to the highest index frame).

Third, the second step is performed until all frames in the GOP are encoded. Subsequent encoding of frames in the next GOP continues until encoding of all GOPs is finished.

In the decoding process, first, a first frame in a GOP is first decoded. Second, frames at the next temporal level are decoded with reference to previously decoded frames. Within the same temporal level, decoding is performed starting from the leftmost frame toward the rightmost (in order from the lowest to the highest index frame). Third, the second step is performed until all frames in the GOP are decoded. Subsequent decoding of frames in the next GOP continues until decoding of all GOPs is finished.

In FIG. 5, symbol “I” indicated within the frame f(O) denotes a frame coded in an intra mode, that is, a frame that does not refer to other frames, and symbol “H” denotes a high-frequency subband frame, that is, a frame coded referring to one or more frames.

Meanwhile, as an illustration of the present invention, as shown in FIG. 5, when a GOP size is 8, temporal levels of the frame may be in the order (0), (4), (2, 6), and (1, 3, 5, 7). Temporal levels in the order (1), (5), (3, 7), and (0, 2, 4, 6) may be employed without any problem associated with temporal scalability in both the encoding and decoding parts (for example, when the frame f(1) is an I frame). Similarly, temporal levels in the order (2), (6), (0, 4), and (1, 3, 5, 7) may also be employed (for example, when the frame f(2) is an I frame). In other words, any frames at the temporal level that can satisfy the encoder-side temporal scalability and the decoder-side temporal scalability are permissible.

However, when temporal scalability is implemented in an order of the temporal levels of (0), (5), (2, 6), and (1, 3, 4, 7), intervals among frames become undesirably irregular while satisfying temporal scalabilities in the encoder and decoder.

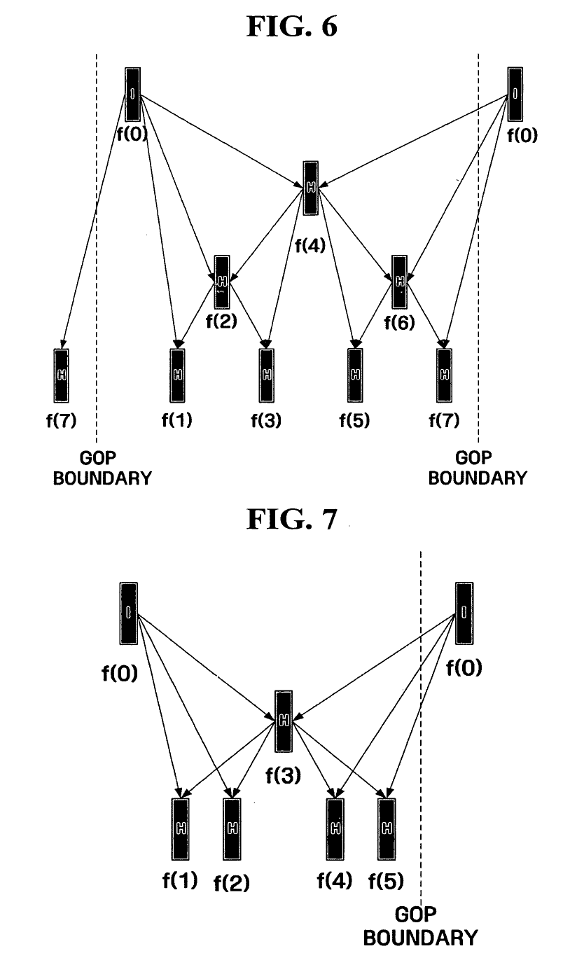

FIG. 6 illustrates bidirectional prediction and cross-GOP optimization used in the STAR algorithm according to another embodiment of the present invention.

In the STAR algorithm, frames referring to frames in another GOP, which is called cross-GOP optimization, can be coded. The cross-GOP optimization can also be supported by the UMCTF algorithm. Since the UMCTF and the STAR coding algorithms use temporally unfiltered A or I frames, they enable cross-GOP optimization. Referring to FIG. 5, a prediction error of a frame f(7) is obtained by adding prediction errors of frames f(0), f(4), and f(6). However, if the frame f(7) refers to the frame f(0) of the next GOP, corresponding to a frame f(8) as computed by the current GOP, accumulation of prediction errors can be noticeably reduced. In addition, since the frame f(0) of the next GOP is a frame coded in an intra mode, the quality of the frame f(7) can be markedly improved.

FIG. 7 illustrates non-dyadic temporal filtering in the STAR algorithm according to still another embodiment of the present invention.

Like in the UMCTF coding algorithm in which A frames can be arbitrarily inserted to support a non-dyadic temporal filtering, the STAR algorithm can also support the non-dyadic temporal filtering simply by changing a graphic structure. The illustrative embodiment of the present invention shows that ⅓ and ⅙ temporal filtering schemes are supported. In the STAR algorithm, a variable frame rate can be easily obtained by changing a graphic structure.

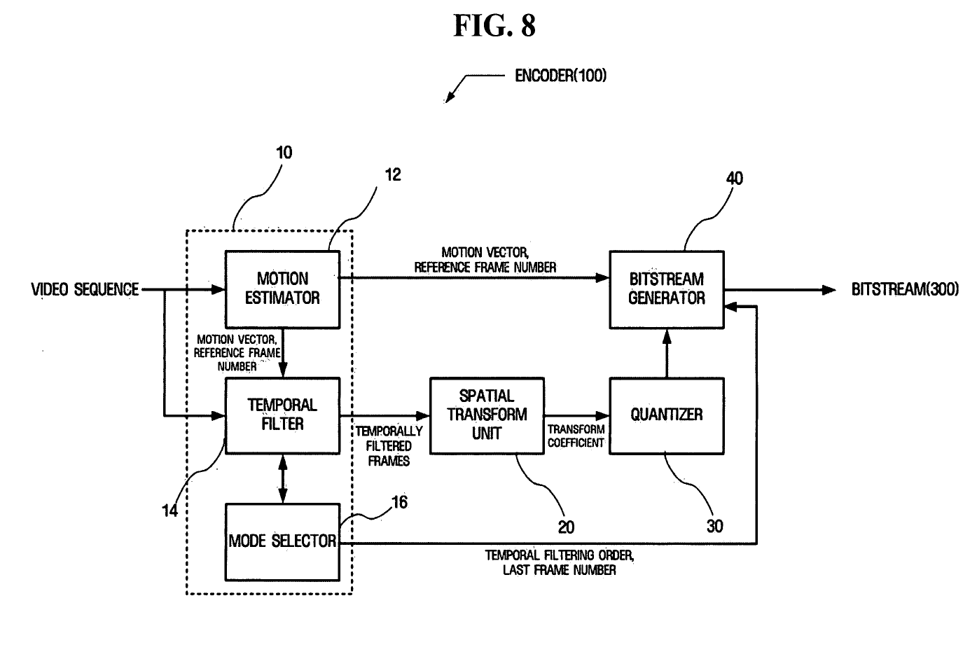

FIG. 8 is a block diagram of a scalable video encoder 100 according to an embodiment of the present invention.

The encoder 100 receives a plurality of frames forming a video sequence, compresses the same to generate a bitstream 300. To this end, the scalable video encoder 100 includes a temporal transform unit 10 removing temporal redundancies from a plurality of frames, a spatial transform unit 20 removing spatial redundancy from the plurality of frames, a quantizer 30 quantizing transform coefficients generated by removing the temporal and spatial redundancies from the plurality of frames, and a bitstream generator 40 generating a bitstream 300 containing quantized the transform coefficients and other information.

The temporal transform unit 10 for compensating motions among frames and performing temporal filtering, includes a motion estimator 12, a temporal filter 14, and a mode selector 16.

First, the motion estimator 12 obtains motion vectors between each macro block of a frame currently being subjected to temporal filtering and a macro block of a reference frame corresponding to the current frame. The information on the motion vectors is supplied to the temporal filter 14. Then, the temporal filter 14 performs temporal filtering on the plurality of frames using the information on the motion vectors. In the illustrative embodiment of the present invention, the temporal filtering is performed in units of GOPS.

The mode selector 16 determines an order of temporal filtering. In the illustrative embodiment of the present invention, the temporal filtering is basically performed in an order from a frame having a high temporal level to a frame having a low temporal level. For frames in the same temporal level, the temporal filtering is performed in an order from a frame having a small frame index to a frame having a large frame index. The frame index is an index indicating a temporal order of frames constituting a GOP. Assuming that the number of frames constituting a GOP is n, the temporally foremost frame is 0 in frame index, and the temporally last frame is n−1 in frame index. The mode selector 16 transfers the information on the temporal filtering order to the bitstream generator 40.

In the illustrative embodiment of the present invention, a frame having the smallest frame index is used as the frame of the highest temporal level among frames constituting a GOP, however, this is only an example. That is, it should be appreciated that selecting another frame in a GOP as a frame having the highest temporal level can be made within the technical scope and principles of the present invention.

In addition, the mode selector 16 determines a predetermined time limit required by the temporal filter 14, hereinafter ‘Tf’. The predetermined time limit is appropriately determined to enable smooth real-time streaming between the encoder and the decoder. Further, the mode selector 16 identifies a number of the last frame in the temporal filtering order, among frames filtered until Tf is reached to then transmit the same to the bitstream generator 40.

In the temporal filter 14, ‘the predetermined time limit’ as a condition determining to which frame a temporal filtering is to be performed, means whether the Tf requirement is satisfied or not.

The requirement for the smooth real-time streaming includes, for example, a possibility of temporally filtering an input video sequence to be adjustable to a frame rate thereof. Assuming that a video sequence is processed at a frame rate of 16 frames per second, if only 10 frames are processed by the temporal filter 14 in one second, the temporal filter 14 will be unable to satisfy smooth real-time streaming. In addition, the processing time required in steps other than the temporal filtering step must be considered in determining Tf even if the temporal filter 14 is able to process 16 frames per second.

Frames from which the temporal redundancies have been removed, that is, temporally filtered frames, are subjected to spatial removal by the spatial transform unit 20. The spatial transform unit 20 removes spatial redundancies of the temporally filtered frames. In the illustrative embodiment of the present invention, a wavelet transform is used. In the known wavelet transform technique, a frame is decomposed into four sections, a quadrant of the frame is replaced with a reduced image (referred to as an L image), which is similar to an entire image of the frame and has ¼ the area of the entire image, and the other three quadrants of the frame are replaced with information (referred to as an H image) used to recover the entire image from the L image. In the same manner, an L image can be replaced with an LL image having ¼ the area of the L image and information used to recover the L image. A compression method referred to as JPEG2000 uses such a wavelet image compression method. Unlike a DCT image, a wavelet-transformed image includes original image information and enables video coding having spatial scalability using a reduced image. However, the wavelet transform is provided for illustration only. In a case where spatial scalability does not have to be provided, a DCT method, which has widely been conventionally used for motion compression like in MPEG-2, may be employed.

The temporally filtered frames are converted to transform coefficients by spatial transformation. The transform coefficients are then delivered to the quantizer 30 for quantization. The quantizer 30 quantizes the real-number transform coefficients with integer-valued coefficients. By performing quantization on transform coefficients, it is possible to reduce the amount of information to be transmitted. In the illustrative embodiment of the present invention, embedded quantization is used to quantize the transform coefficients. That is, it is possible to not only reduce the amount of information to be transmitted but to also achieve signal-to-noise ratio (SNR) scalability using embedded quantization. The term “embedded quantization” is used to mean quantization that is implied by a coded bitstream. In other words, compressed data is tagged by visual importance. In practice, a quantization level (visual importance) can be adjusted at a decoder or at a transmission channel. If a transmission bandwidth, storage capacity or display resources permit, image restoration can be made without loss. If not, restrictions of display resources determine the quantization requirement for the images. Currently known embedded quantization algorithms include Embedded Zerotrees Wavelet Algorithm (EZW), Set Partitioning in Hierarchical Trees (SPIHT), Embedded ZeroBlock Coding (EZBC), and Embedded Block Coding with Optimal Truncation (EBCOT).

The bitstream generator 40 generates the bitstream 300 with a header attached thereto, the bitstream 300 containing information on encoded images (frames) and information on motion vectors obtained from the motion estimator 12. In addition, the information may include the temporal filtering order transferred from the mode selector 16, the frame number of the last frame, and so on.

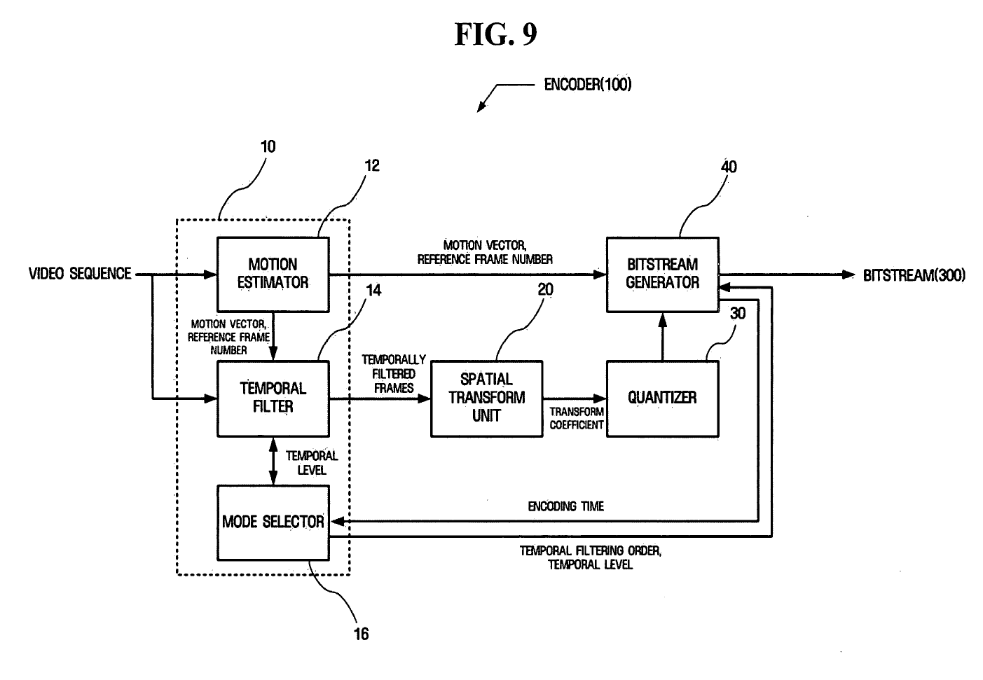

FIG. 9 is a block diagram of a scalable video encoder according to another embodiment of the present invention.

The scalable video encoder according to this embodiment is substantially the same as that shown in FIG. 8, except that the mode selector 16 can receive from the bitstream generator 40 a time required for finally encoding the frame in a GOP in a predetermined temporal level, hereinafter referred to as an “encoding time,” as well as determining the temporal filtering order and transferring the same to the bitstream generator 40, as shown in FIG. 8.

In addition, the mode selector 16 determines a predetermined time limit required by the temporal filter 14, hereinafter ‘Ef’. The predetermined time limit is appropriately determined to enable smooth real-time streaming between the encoder and the decoder. Further, the mode selector 16 compares Ef with the encoding time received from the bitstream generator 40. If the encoding time is greater than Ef, the mode selector 16 sets an encoding mode in which temporal filtering is performed in a temporal level that is one level higher than the current temporal level, thereby making the encoding time smaller than Ef to satisfy the Ef requirement.

In this case, ‘the predetermined time limit’ as a condition for determining to which frame temporal filtering is to be performed, means whether the Ef requirement is satisfied or not.

The requirement for the smooth real-time streaming includes, for example, a possibility of generating the bitstream 300 to be adjustable to a frame rate of an input video sequence. Assuming that a video sequence is processed at a frame rate of 16 frames per second, if only 10 frames are processed by the encoder 100 in one second, smooth real-time streaming cannot be realized.

Suppose a GOP is composed of 8 frames. If an encoding time required for processing the current GOP is greater than Ef, the mode selector 16, which has received the encoding time from the bitstream generator 40, requests the temporal filter 14 to increase a temporal level by one level. Then, from the next GOP, the temporal filter 14 performs temporal filtering on frames in a temporal level that is one level higher than the current temporal level, that is, only four frames preceding in a temporal filtering order.

Otherwise, if the encoding time is smaller than Ef by a predetermined threshold, the mode selector 16 requests the temporal filter 14 to lower a temporal level by one level.

In such a manner, temporal scalability of the encoder 100 can be adaptively implemented based on the processing power of the encoder 100 by adjustably varying the temporal level according to situations.

Meanwhile, the bitstream generator 40 generates the bitstream 300 with a header attached thereto, the bitstream 300 containing information on encoded images (frames) and information on motion vectors obtained from the motion estimator 12. In addition, the bitstream 300 may include information on the temporal filtering order transferred from the mode selector 16, the temporal level, and so on.

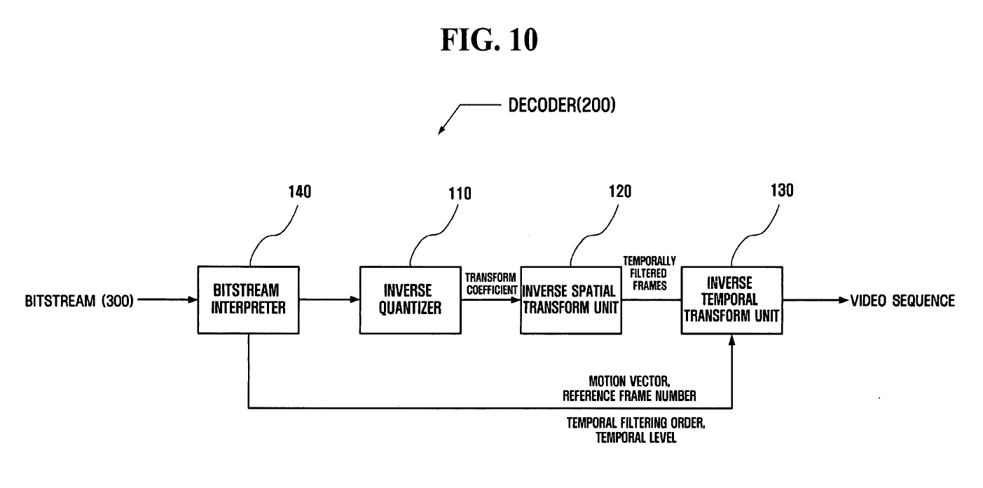

FIG. 10 is a block diagram of a scalable video decoder 200 according to an embodiment of the present invention.

The scalable video decoder 200 includes a bitstream interpreter 140, an inverse quantizer 110, an inverse spatial transform unit 120, and an inverse temporal filter 130.

First, the bitstream interpreter 140 interprets an input bitstream to extract information on encoded images (encoded frames), motion vectors and a temporal filtering order, and the bitstream interpreter 140 transfers the information on the motion vectors and the temporal filtering order to the inverse temporal filter 130.

The information on the temporal filtering order corresponds to the frame number of the last frame in the embodiment shown in FIG. 8, and the temporal level determined during encoding in the embodiment shown in FIG. 9, respectively. The temporal level determined during encoding is used as a temporal level of a frame to be subjected to inverse temporal filtering. The frame number of the last frame is used to search for temporal levels that can be formed by frames having frame numbers smaller than or equal to the frame number of the last frame to be subjected to inverse temporal filtering.

For example, referring back to FIG. 5, suppose the temporal filtering order is (0, 4, 2, 6, 1, 3, 5, 7) and the frame number of the last frame is 3. Then, the bitstream interpreter 140 transfers a temporal level of 2 to the inverse temporal filter 130, so that the inverse temporal filter 130 restores the frames corresponding to the temporal level 2, that is, frames f(0), f(4), f(2), and f(6). In this case, the frame rate is a half that of the original frame rate.

The information on the encoded frames is inversely quantized and converted into transform coefficients by the inverse quantizer 110. The transform coefficients are inversely spatially transformed by the inverse spatial transform unit 120. The inverse spatial transformation is associated with spatial transformation of the encoded frames. When a wavelet transform is used to perform the spatial transform, the inverse spatial transformation is achieved by performing an inverse wavelet transform. When a DCT transform is used to perform the spatial transform, the inverse spatial transformation is achieved by performing an inverse DCT. The transform coefficients are converted into I frames and H frames through the inverse spatial transformation.

The inverse temporal filter 130 restores the original video sequence from the I frames and H frames, that is, temporally filtered frames, using the information on the motion vectors, reference frame number, that is, information on which frame is used as a reference frame, and information on a temporal filtering order, which are received from the bitstream interpreter 140.

Here, the inverse temporal filter 130 restores only the frames corresponding to the temporal level received from the bitstream interpreter 140.

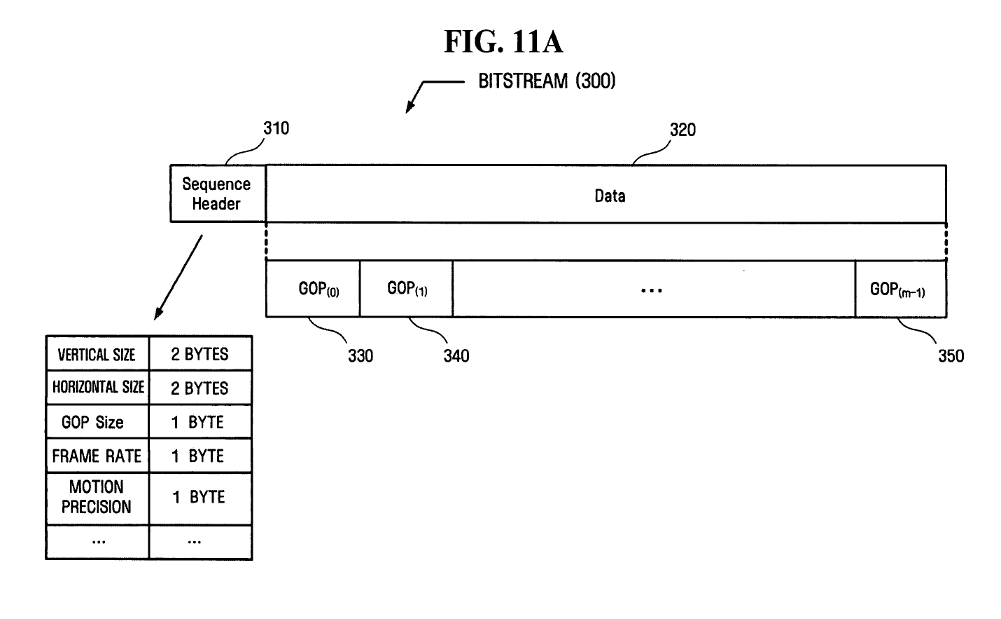

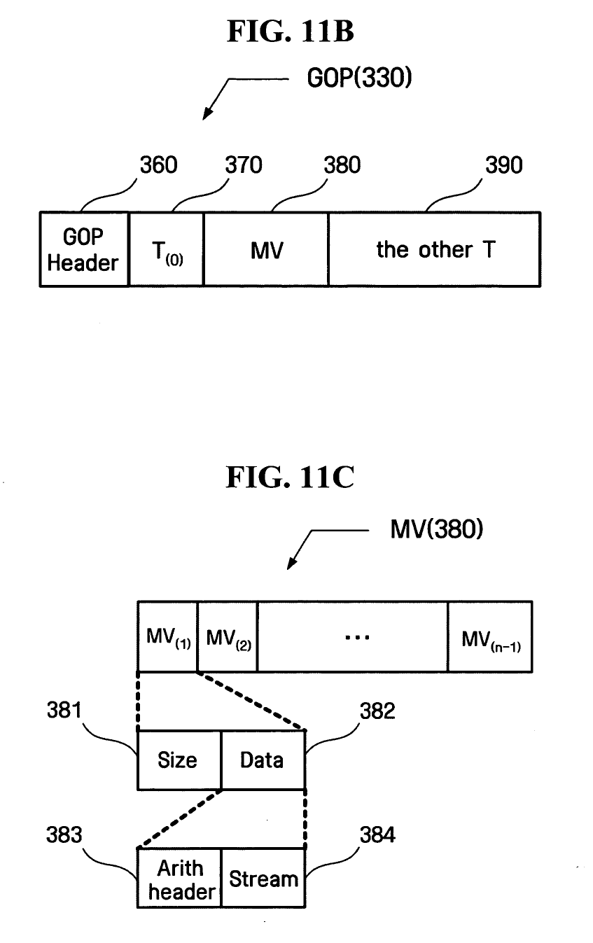

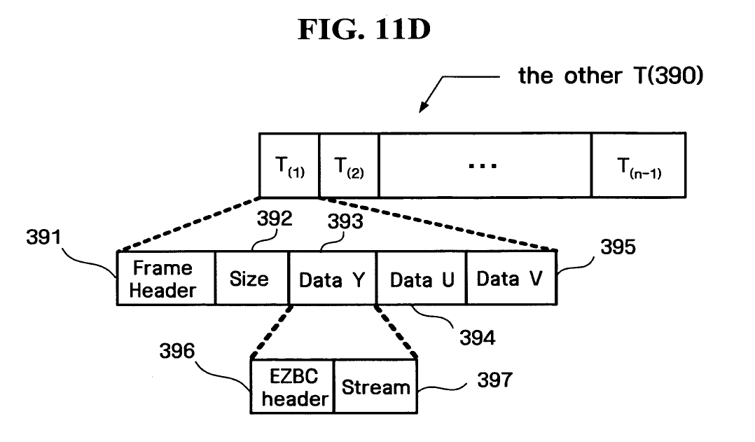

FIGS. 11A through 11D illustrate a structure of a bitstream 300 according to the present invention. Specifically, FIG. 11A schematically illustrates the overall structure of a bitstream 300 generated by an encoder.

The bitstream 300 includes a sequence header field 310, and a data field 320, the data field 320 including one or more GOP fields 330, 340, and 350.

Overall image features, including a frame length (2 bytes), a frame width (2 bytes), a GOP size (1 byte), a frame rate (1 byte) and a degree of motion precision (1 byte) are recorded in the sequence header field 310.

Overall image information and other information necessary for image restoration, such as motion vectors, a reference frame number, or the like are recorded in the data field 320.

FIG. 11B illustrates a detail structure of each of various GOP fields 330, 340, 350.

The GOP field 330 includes a GOP header 360, a T(0) field 370 in which information on the first frame (an I frame) in view of the temporal filtering order is recorded, a MV field 380 in which sets of motion vectors is recorded, and a ‘the other T’ field 390 in which information on frames (H frames) other than the first frame (an I frame) is recoded.

Unlike in the sequence header field 310 in which the overall image features are recorded, limited image features in a pertinent GOP are recorded in the GOP header field 360. Specifically, a temporal filtering order may be recorded in the GOP header field 360, or a temporal level in the embodiment shown in FIG. 9, which is, however, on the assumption that the information recorded in the GOP header field 360 is different from that recoded in the sequence header field 310. In a case where the same temporal filtering order or temporal level is used for the overall image, the corresponding information is advantageously recorded in the sequence header field 310.

FIG. 11C is a detailed diagram of an MC field 380.

The MV field 380 includes as many fields as the number of motion vectors, each motion vector field MV₍₁₎, MV₍₂₎, . . . , MV₍ₙ₋₁₎ having a motion vector recorded therein. Each motion vector field MV₍₁₎, MV₍₂₎, . . . , MV₍ₙ₋₁₎ is further divided into a size field 381 indicating a size of a motion vector, and a data field 382 in which actual data of the motion vector is recorded. In addition, the data field 382 includes a header 383 and a stream field 384. The header 383 has information based on an arithmetic encoding method by way of example. Otherwise, the header 383 may have information on other coding methods, e.g., Huffmann coding. The stream field 384 has binary information on an actual motion vector recorded therein.

FIG. 11D is a detailed diagram of a ‘the other T’ field 390, in which information on H frames of a number equal to the number of frames minus one.

The field 390 containing the information on each of the H frames, is further divided into a frame header field 391, a data Y field 393 in which brightness components of the H frame are recorded, a Data U field 394 in which blue chrominance components are recorded, a Data V field 395 in which red chrominance components are recorded, and a size field 392 indicating a size of each of the Data Y field 393, the Data U field 394, and the Data V field 395.

In the illustrative embodiment in which EZBC quantization is used, it is described that each of the Data Y field 393, the Data U field 394, and the Data V field 395 includes an EZBC header field 396, and a stream field 397, which is based on the assumption that EZBC quantization is employed by way of example. That is, when another method such as EZW or SPHIT is employed, the information corresponding to the method employed will be recorded in the header field 396.

Unlike in the sequence header field 310 or the GOP header field 360 in which the overall image features are recorded, limited image features in a pertinent frame are recorded in the frame header field 391. Specifically, information on the frame number of the last frame may be recorded in the frame header field 391, like in the embodiment shown in FIG. 8. For example, information can be recorded using a specific bit of the frame header field 391. Suppose there are temporally filtered frames T₍₀₎, T₍₁₎, . . . , T₍₇₎. If an encoder performs encoding up to the frame T₍₅₎ and stops encoding, bits of the frames T₍₀₎ through T₍₄₎ are set to 0 and a bit of the last frame T₍₅₎ among the encoded frames T₍₀₎ through T₍₅₎ is set to 1, thereby allowing the decoder to identify the frame number of the last frame using the bit specified by 1.

Meanwhile, the frame number of the last frame can be recorded in the GOP header field 360, which may be, however, less effective than being recorded in the frame header field 391 in a case where real-time streaming is requested and is important. This is because a GOP header is not generated until the last encoded frame is determined in a current GOP.

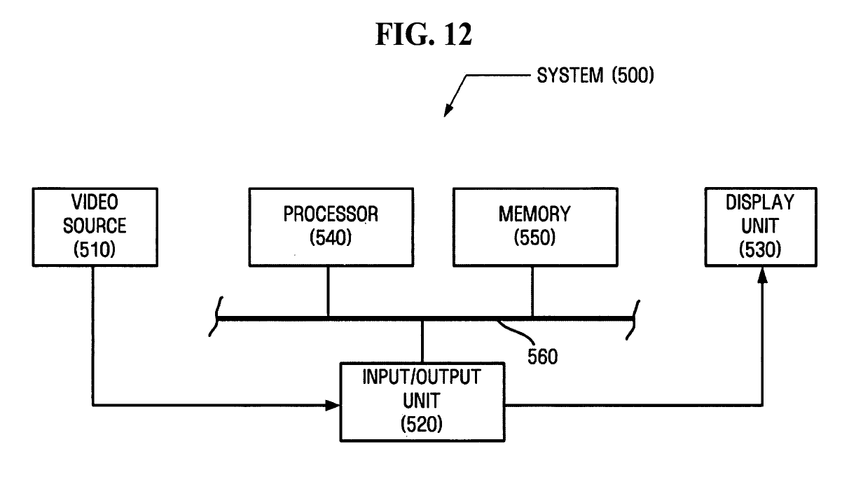

FIG. 12 is a block diagram of a system 500 in which the encoder 100 and the decoder 200 according to an embodiment of the present invention operate. The system 50 may be a television (TV), a set-top box, a desktop, laptop, or palmtop computer, a personal digital assistant (PDA), or a video or image storing apparatus (e.g., a video cassette recorder (VCR) or a digital video recorder (DVR)). In addition, the system 500 may be a combination of the above-mentioned apparatuses or one of the apparatuses which includes a part of another apparatus among them. The system includes at least one video/image source 510, at least one input/output unit 520, a processor 540, a memory 550, and a display unit 530.

The video/image source 510 may be a TV receiver, a VCR, or other video/image storing apparatus. The video/image source 510 may indicate at least one network connection for receiving a video or an image from a server using Internet, a wide area network (WAN), a local area network (LAN), a terrestrial broadcast system, a cable network, a satellite communication network, a wireless network, a telephone network, or the like. In addition, the video/image source 510 may be a combination of the networks or one network including a part of another network among the networks.

The input/output unit 520, the processor 540, and the memory 550 communicate with one another through a communication medium 560. The communication medium 560 may be a communication bus, a communication network, or at least one internal connection circuit. Input video/image data received from the video/image source 510 can be processed by the processor 540 using at least one software program stored in the memory 550 and can be executed by the processor 540 to generate an output video/image provided to the display unit 530.

In particular, the software program stored in the memory 550 includes a scalable wavelet-based codec performing a method of the present invention. The codec may be stored in the memory 550, may be read from a storage medium such as a compact disc-read only memory (CD-ROM) or a floppy disc, or may be downloaded from a predetermined server through a variety of networks. In addition, the codec may be replaced by a hardware circuit using the software or by a combination of the software and the hardware circuit.

Although only a few exemplary embodiments of the present invention have been shown and described with reference to the attached drawings, it will be understood by those skilled in the art that changes may be made to these elements without departing from the features and spirit of the invention. Therefore, it is to be understood that the above-described embodiments have been provided only in a descriptive sense and will not be construed as placing any limitation on the scope of the invention.

According to the present invention, since scalability is provided in the encoder part, stability in the operation of real-time, bidirectional video streaming applications, such as video conferencing, can be ensured.

In addition, since the decoder part receives information on an encoding process, that is, information on some of frames that have undergone the encoding process, from the encoder part, the decoder can restore the frames without having to wait until the frames in a GOP are all received.

1. A scalable video encoding apparatus comprising:
a mode selector that determines an order of temporally filtering a frame and a predetermined time limit as a condition for determining to which frame temporal filtering is to be performed; and
a temporal filter which performs motion compensation and temporal filtering, according to the temporal filtering order determined in the mode selector, on frames that satisfy the condition.

2. The scalable video encoding apparatus of claim 1, wherein the predetermined time limit is determined to enable smooth, real-time streaming.

3. The scalable video encoding apparatus of claim 1, wherein the temporal filtering order is from frames of a high temporal level to frames of a low temporal level.

4. The scalable video encoding apparatus of claim 1, further comprising a motion estimator that obtains motion vectors between a frame currently being subjected to temporal filtering and a reference frame corresponding to the current frame and transfers the reference frame number and the obtained motion vectors to the temporal filter for motion compensation.

5. The scalable video encoding apparatus of claim 4, further comprising:
a spatial transform unit that removes spatial redundancies from the temporally filtered frames to generate transform coefficients; and
a quantizer that quantizes the transform coefficients.

6. The scalable video encoding apparatus of claim 5, further comprising a bitstream generator that generates a bitstream containing a frame number of a last frame in the temporal filtering order, the motion vectors obtained from the motion estimator, the temporal filtering order transferred from the mode selector, and the predetermined time limit.

7. The scalable video encoding apparatus of claim 6, wherein the temporal filtering order is recorded in a GOP header contained in each GOP within the bitstream.

8. The scalable video encoding apparatus of claim 6, wherein the frame number of the last frame is recorded in a frame header contained in each frame within the bitstream.

9. The scalable video encoding apparatus of claim 5, further comprising a bitstream generator which generates a bitstream including information on a temporal level formed by the frames, the motion vectors obtained from the motion estimator, the temporal filtering order transferred from the mode selector, and the predetermined time limit.

10. The scalable video encoding apparatus of claim 9, wherein the information on the temporal level is recorded in a GOP header contained in each GOP within the bitstream.

11. A scalable video decoding apparatus comprising:
a bitstream interpreter that interprets an input bitstream to extract information on encoded frames, motion vectors, a temporal filtering order of the frames, and a temporal level of frames to be subjected to inverse temporal filtering; and
an inverse temporal filter that performs inverse temporal filtering on a frame corresponding to the temporal level among the encoded frames to restore a video sequence.

12. A scalable video decoding apparatus comprising:
a bitstream interpreter that interprets an input bitstream to extract information on encoded frames, motion vectors, a temporal filtering order of the frames, and a temporal level of frames to be subjected to inverse temporal filtering;
an inverse quantizer that performs inverse quantization on the information on encoded frames to generate transform coefficients;
an inverse spatial transform unit that performs inverse spatial transformation on the generated transform coefficients to generate temporally filtered frames; and
an inverse temporal filter that performs inverse temporal filtering on a frame corresponding to the temporal level among the temporally filtered frames to restore a video sequence.

13. The scalable video decoding apparatus of claim 11, wherein the information on the temporal level is a frame number of a last frame in the temporal filtering order among the encoded frames.

14. The scalable video decoding apparatus of claim 11, wherein the information on the temporal level is the temporal level determined when encoding the bitstream.

15. The scalable video decoding apparatus of claim 13, wherein the frame number of the last frame is recorded in a frame header contained in each frame within the bitstream.

16. The scalable video decoding apparatus of claim 14, wherein the information on the temporal level is recorded in a GOP header contained in each GOP within the bitstream.

17. A scalable video encoding method comprising:
determining a temporal filtering order of a frame and a predetermined time limit as a condition for determining to which frame temporal filtering is to be performed; and
performing motion compensation and temporal filtering, according to the determined temporal filtering order, on frames that satisfy the condition.

18. The scalable video encoding method of claim 17, wherein the predetermined time limit is determined to enable smooth, real-time streaming.

19. The scalable video encoding method of claim 17, wherein the temporal filtering order from frames of a high temporal level to frames of a low temporal level.

20. The scalable video encoding method of claim 17, further comprising obtaining motion vectors between a frame currently being subjected to temporal filtering and a reference frame corresponding to the current frame.

21. A scalable video decoding method comprising:
interpreting an input bitstream to extract information on encoded frames, motion vectors, a temporal filtering order of the frames, and a temporal level of frames to be subjected to inverse temporal filtering; and
performing inverse temporal filtering on a frame corresponding to the temporal level among the encoded frames to restore a video sequence.

22. The scalable video decoding method of claim 21, wherein the information on the temporal level is a frame number of a last frame in the temporal filtering order among the encoded frames.

23. The scalable video decoding method of claim 21, wherein the information on the temporal level is the temporal level determined when encoding the bitstream.

24. A recording medium having a computer readable program recorded therein, the program for executing the method of claim 17.
